(19) United States
(12) Patent Application Publication
(10) Pub. No.: US 2002/0049751 A1
(43) Pub. Date: Apr. 25, 2002

(54) Managing contact information through a communication network

(76) Inventors: Mei-Na Chen, Cupertino, CA (US); Shih-Hui Lu, Fremont, CA (US)

Correspondence Address: FRANK R. OCCHIUTI, Fish & Richardson P.C., 225 Franklin Street, Boston, MA, 02110-2804, US

(21) Appl. No.: 09/845,567

(22) Filed: Apr. 30, 2001

Related U.S. Application Data
(60) Provisional application No. 60/229,772, filed on Sep. 1, 2000.

(51) Int. Cl. G06F 17/30

(52) U.S. Cl. 707/3; 707/200

(57) ABSTRACT

A method and a system for managing contact information via a communication network are described. The method and the system establish a record for a user, where the record is indexed by an index associated with the user (e.g. the user's email address). The record includes a profile of the user and a list of contacts. Each contact also has a record indexed by a unique index associated with the contact. When it is determined that a change has been made to the user's profile, the system locates each of the contacts in a database using the unique index, and updates the record of each contact with the change to the profile. Through a bi-directional link established between the user and his contact, any changes in the user's record or his contact's record can be seen by each other.

### TECHNICAL FIELD

This invention relates to managing contact information through a communication network.

### BACKGROUND

Business cards have long served as an indispensable way of sharing business information. In most cases, business cards are used to provide printed information relating to a person's professional life. The printed information typically includes the person's name, title, company address, and phone numbers.

With the advent of the Internet, additional information began to be printed on the business cards (e.g., e-mail address, company web site address).

It is generally desirable to have the business contact's printed information transferred into a computer (e.g., PC) or personal digital assistant (PDA) for future use in communicating with the contact. In some cases, the information is manually entered into the computer or PDA. Doing so allows the computer's e-mail application (e.g., the “address book” or “directory” feature of the computer's or PDA's electronic mail utility) to retrieve and manage the contact information. Alternatively, the information can be electronically transferred using, for example, a business card scanner (e.g. CardScan™, a product of Corex technologies, Inc., Cambridge, Mass.) for scanning each card and transferring the printed information into a PC or PDA.

There is no assurance, however, that the information entered into the computer will remain current. In this increasingly mobile society, it is not uncommon for people to change jobs or move from one location to another. Generally, the person's email address or phone number will also change making the information on the person's business card obsolete, without the recipient of the card ever knowing anything about the person's change of status.

When a person or a business entity's business information has changed, the person or business entity typically notifies all its contacts, (e.g. customers, vendors, or partners), using conventional postal mail or email (e.g., “We Have Moved” announcement). Even when such notices are received, however, many recipients do not follow up to enter the updates. Moreover, it is not uncommon for the recipient to unintentionally, keep multiple copies of a directory on the PC such that a comprehensive updating cannot be guaranteed.

### SUMMARY

The invention relates to a method of managing contact information. In one aspect of the invention, the method includes: establishing a first record of a first user; determining that a change has been made to a first profile; locating each of contacts in a database using a unique index; and updating a record of each of the contacts with the change to the first profile. The first record is indexed by a first index associated with the first user, and includes the first profile and a first list of contacts. The record of each of the contacts is indexed by the unique index associated with the contact.

Embodiments of this aspect of the invention may include one or more of the following features. A second user is added into the first list of contacts by inputting a second index of the second user; searching the database to find a second record that includes a indexed by the second index; and linking the second record to the first record if the second record is found. The second record includes a second profile and a second list of contacts

A third record of a third user is established. The third record is indexed by a third index associated with the third user, and includes a third profile and a third list of contacts. The database is searched to find other records that contain the third index associated with the third user; and the other records are linked to the third record if other records are found.

In another aspect of the invention, a method of managing contact information for a group of members includes the following steps: a group record for the group is established. The group record is indexed by an index associated with the group, and includes a group profile and a list of group contacts. Each of the group contacts is a member of the group and has a record. The group record is linked to a record of each of the members.

With this approach, any member of the group is allowed to read the group profile and the profiles of the group members.

In still another aspect of the invention, a system for managing contact information includes: a storage containing a database; and a server operatively connected to the storage. The server is controlled by a server application program and is operative with the program to: establish a first record of the first user; determine that a change has been made to a first profile; locate each of contacts in the database using a unique index; and update a record of each of the contacts with the change to the first profile. The first record is indexed by a first index associated with the first user. The first record includes the first profile and a first list of contacts. The record of each of the contacts is indexed by a unique index associated with the contact.

In certain embodiments of this aspect of the invention, the server application program further controls the server to add a second user into the first list of contacts by inputting a second index of the second user; search the database to find a second record indexed by the second index; and link the second record to the first record if the second record is found. The second record includes a second profile and a second list of contacts

Embodiments of this aspect of the invention may include one or more of the following features. The server application program further controls the server to: establish a third record of the third user; search the database to find other records that contain a third index associated with the third user; and link the other records to the third record if other records are found. The third record is indexed by the third index associated with the third user, and includes a third profile and a third list of contacts

In still another aspect of the invention, a system for managing contact information for a group of members includes a group record indexed by an index associated with the group; and links established between the group record and a record of each member of the group. The group record includes a group profile and a list of group contacts. Each of the group contacts is the member of the group and has a record.

In yet another aspect of the invention, a computer program product residing on a computer readable medium comprising instructions for causing a computer to: establish a first record of a first user; determine that a change has been made to a first profile; locate each of contacts in the database using a unique index; and update a record of each of the contacts with the change to the first profile. The first record is indexed by a first index associated with the first user, and includes the first profile and a first list of contacts, each of the contacts having a record indexed by a unique index associated with the contact.

Embodiments of the above aspects of the invention may include one of more of the following features. The linking includes copying the second profile to the first list of contacts, and copying the first profile to the second list of contacts. The linking is controlled by the second user. The second record can be unlinked from the first record by allowing the second user to reject the first user, thereby preventing the first user from viewing subsequent updates in the second record.

The index associated with the first, the second, the third user, or the group, can be an email address. The updating occurs when the first user submits the change to the first profile. The updating occurs when a contact in the first list of contacts views the first profile. The searching the database includes searching a plurality of databases, all of the databases conforming to a format for information storage and retrieval.

The first record can be indexed by a plurality of indices associated with the first user. The first profile can include a plurality of information levels, each level including different information relating to the first user, wherein the first user designates which of the information levels are accessible by a contact in the first list of contacts.

The storage in the system can include a plurality of storage units operatively connected through a network. The server in the system can also include a plurality of processing units operatively connected through the network.

Embodiments may have one of more of the following advantages. The method and the system allow a user to access to current information of his contact by entering an index of that contact. The user does not need to update the information each time when the information of his contact changes. Neither does the user need to notify his contact when he has a change of status. Through a bi-directional link established between the user and his contact, any changes in the information of his contact will propagate to the user, and vice versa.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a system diagram including servers and storage units that are connected to users via a network for managing contact information;

FIG. 2 illustrates a record associated with a user in a database stored in the storage units;

FIG. 3 illustrates a server application stored in one of the servers, and a client application stored at the user's location;

FIG. 4 is a flow diagram illustrating the process of managing contact information, including building a profile and a contact list for a user; and

FIG. 5 is a flow diagram illustrating the process of updating the profile.

Like reference symbols in the various drawings indicate like elements.

### DETAILED DESCRIPTION

A method and system for managing contact information using a communication network, (e.g., the Internet) is disclosed. In the description that follows, numerous items are set forth in detail to provide a more thorough understanding of the present invention. It will be apparent, however, to one ordinarily skilled in the art that the present invention may be practiced without these specific details. In other instances, well-known features have been described in general terms so as not to obscure the present invention.

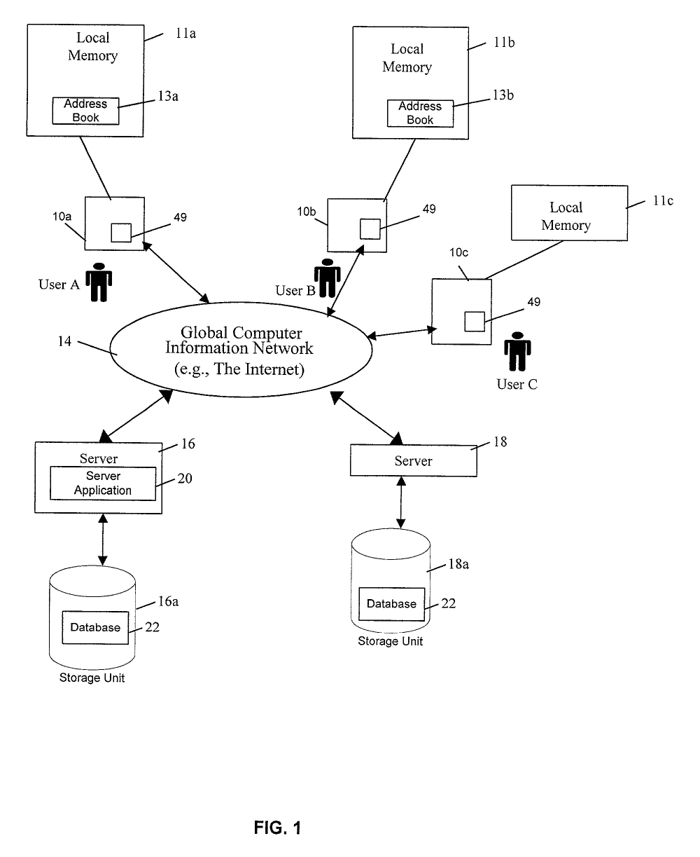

Referring to FIG. 1, a user A, a user B, and a user C, each representing a client, are shown having access to servers 16, 18 using their respective client machines (10a, 10b, 10c). Each client machine (10a, 10b, 10c) is connected to the servers 16, 18 via a global communications network 14 (e.g., the Internet or a wide area network (WAN)). In this embodiment, servers 16 and 18 communicate using a common communication protocol, e.g. TCP/IP. Servers 16 and 18 have associated storage units 16a and 18a, respectively, and but can access each other's storage units. Server 16 hosts a server application 20 that provides contact information management service for the users, as will be discussed in detail below. When one of the users submits a request for contact information to server 16, server application 20 searches one or more databases 22 in the local storage unit 16a or one or more remote storage units (e.g., storage unit 18a), and retrieves the requested contact information. Server application 20 allows a registered user to maintain a record in database 22. The record is indexed by the user's email address.

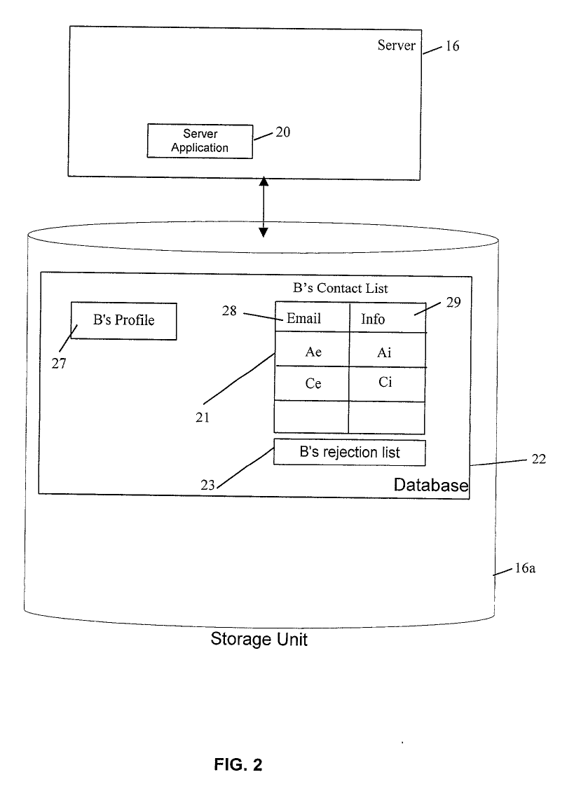

Referring to FIG. 2, an example of a record for a registered user, user B, in database 22 is illustrated. User B's record includes a profile 27 representing an electronic business card, and a contact list 21 (i.e., a Rolodex) containing a list of contacts (e.g., customers, suppliers and affiliates) of user B. Each contact in the list also has a record in database 22 that contains a profile and a contact list of that contact, if that contact is registered. For example, if user A is a contact listed in user B's contact list, user A's profile and contact list is stored in database 22. User A's record is indexed, likewise, by his email address. Once a record is set up for a user, he can update his profile and view the profiles of all the registered contacts in his contact list.

User B's contact list 21 contains information 29 about B's contacts (in the example, user A and user C). Information 29 contains a copy of user A's profile and a copy of user C's profile. Each of the profiles is indexed by its associated user's email address 28. If user A updates his information, the update will be propagated to user B's contact list 21 and updates information Ai.

User B also has a rejection list 23 stored in database 22. Rejection list 23 includes a list of contacts that originally resided in contact list 21, but have subsequently been rejected by user B. The rejection of a contact will be described in detail below.

If user A (e.g., the contact) is registered, user B can obtain a copy of user A's profile by simply entering user A's email address in the contact list. However, if user A is not registered, his profile does not exist in database 22 and therefore is not accessible. To save contact information for an unregistered contact in the user B's contact list 21, user B must enter all information about the contact. Thus, the greater the number of users that are registered to use the contact management service, the greater likelihood that a contact's profile will exist in database 22, and the easier it is for a user to build his contact list.

Referring again to FIG. 1, a local copy of user A's contact list, including the profiles or contact information of all his contacts, can be downloaded into user A's local memory 11a in an electronic address book 13a. Downloading the contact list allows user A to access the list locally, without having to access network 14 each time a contact referenced. However, it is possible that the local copy may not be current and have the most “up-to-date” information. This can occur because updates made by the contacts will not be seen by the local copy. If a user chooses not to download a local copy, as in the example of user C, the contact information can be maintained remotely in database 22 via network 14. User C can be assured that the information in his contact list will always stay current, because server application 20 continuously monitors any updates and new entries that enter database 22, and propagates the updates to user C's contact list automatically.

Client machines 10a, 10b, 10c represent processing units locally accessible to a user, (e.g., a PC or a PDA). Each of the client machines 10a, 10b, 10c has an associated local memory 11a, 11b, 11c, and hosts a client application 49 that interacts with server application 20. Client application 49 provides an interface for a user to submit and view information on client machine 10. It also allows a user to effectively transfer and synchronize data between database 22 and local memory 1.

As will be described in greater detail below, when a new user creates a new profile in database 22, or an existing user updates information in his profile, the new or updated profile will be propagated to all of the user's contacts. The changes in a profile are propagated through links between the profile and contacts. The link between a user and his contact is bi-directional, that is, when such a link exists, updates in the user's profile will be seen by his contact, and updates in his contact's profile will also be seen by the user. In particular, a user's profile is linked to his contacts by an index to the user's record, i.e., the profile is linked to his contacts by his email address.

A user's email address can be used to link a user's profile to his contacts. Other linking methods may also be used, so long as the chosen method can uniquely identify a user. For example, a person's telephone number with country code and area code can also be used as a link.

It should be noted that server 16 can include a number of processors connected by a network accessible to users. The processors can function as one single server with the exchange of messages between the processors being transparent to the users. With a common data format and transmission protocol, processors and databases owned by different business entities or organizations can be linked together to provide broader service coverage to users. That is, any changes and updates that take place in one company's database will propagate to another company's database if both companies have agreed to share their users' contact information.

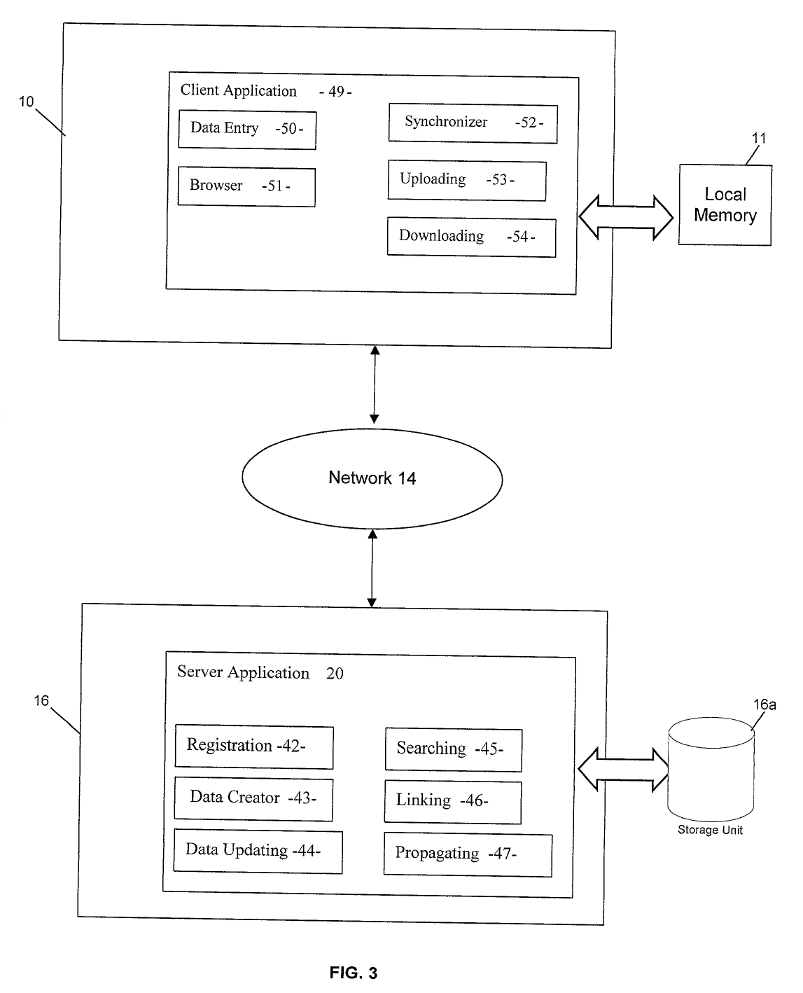

Referring to FIG. 3, software components of server application 20 and client application 49 are shown. Server application 20 allows a user to manage his profile and contact list effectively. When any change in the information of a contact occurs, server application 20 causes relevant records in database 22 to be updated accordingly, and automatically propagated to any users having a contact list that lists the contact. Server application 20 includes a registration module 42, a data creator module 43, a data updating module 44, a searching module 45, a linking module 46 and a propagating module 47. Before a user is allowed to create his profile, the use must first register using registration module 42. Once the user is registered, the user creates his profile and contact list using data creator module 43. Searching module 45 then searches database 22 to find the profiles of any contacts in the user's contact list. For each contact, linking module 46 establishes a bi-directional link between the user and the contact. As a result, a change of profile made on either side of the link will be seen by the other side. Propagation module 47 propagates the user's profile to the contact's contact list, and the contact's profile to the user's contact list by copying their profiles to each other's contact list.

Client application 49, on the other hand, can be configured for the user to access server application 20 via network 14, and to view and store his contact list locally. Client application 49 includes a data entry module 50 for accepting user data, a browser 51 (e.g., Microsoft Internet Explorer 5.0) for displaying Web-based data files, a synchronizer 52 for synchronizing local address book 13 with remote data, an uploading module 53 for uploading information in local memory 11 to database 22, and a downloading module 54 for downloading user record to the user's local address book 13.

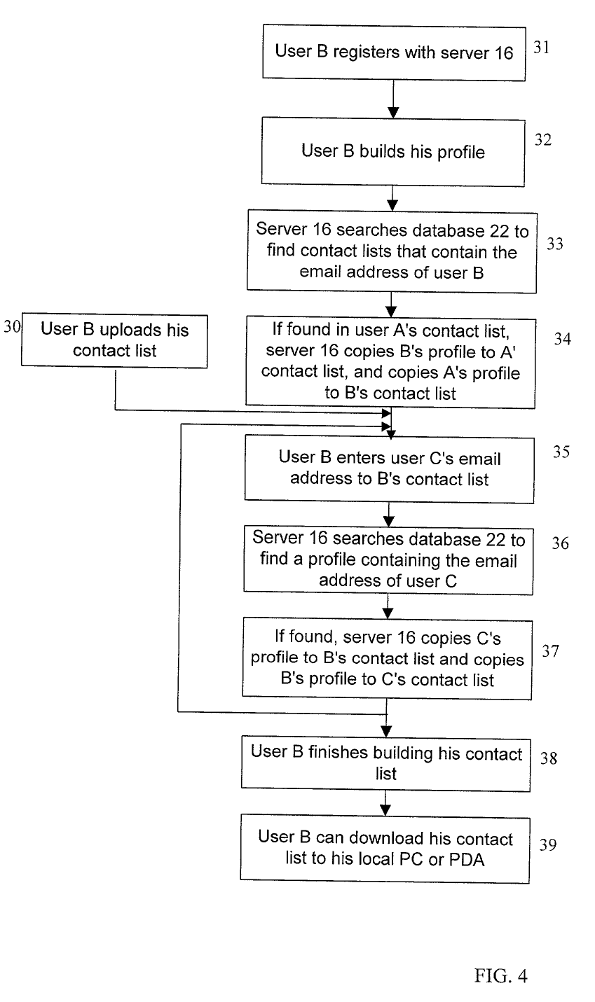

Referring to FIG. 4, a flow diagram of one embodiment of the present invention is shown. In this embodiment, it is assumed that user A has registered with server 16 and has created his profile.

User B logs onto server 16 for the first time and registers using registration module 42 in server application 20 (step 31). Registration module 42 requires user B to enter certain personal information, such as first and last name, and select login information, such as a sign-in name and a password. User B then builds his profile, including his email address, and other contact information ordinarily provided on one's business card (step 32). Once user B completes the registration, he can access server 16 again at a later time following a sign-on procedure requiring only his sign-in name and password.

After user B creates his profile, searching module 45 matches user B's email address with all other contact lists created by other registered users registered in server 16 (step 33). For example, if user A's contact list contains user B's email address, server application 20 will automatically bring user A's profile into user B's contact list, even if user B has not added user A in user B's contact list. As a result, user B's profile will be copied to user A's contact list. Because the link between two records is bi-directional, user A's profile will also be copied to user B's contact list, thus allowing both users to view each other's profile (step 34).

If user A has not included user B in user A's contact list, and user B now adds user A as a contact by entering user A's email address, searching module 45 will search database 22 to find user A's profile, using user A's email address as a key for the search. When searching module 45 finds user A's, user A's profile is copied to user B's contact list, and user B's profile will also be copied to user A's contact list.

When building his contact list, user B can either upload a contact list file from local memory 11b of associated client machine 10b (step 30), or enter the contact information manually, one contact after another (step 35). When entering a contact's information, user B need not laboriously enter all the information about the contact. Rather, user B only needs to enter the email address of the contact. The email address will serve as a link for retrieving the contact's profile.

Furthermore, assume that user B wishes to include user C a contact by entering user C's email address (step 35). Once user C's email address is entered, searching module 45 searches database 22 to find user C's profile using user C's email address as a key for the search (step 36). If user C's email address is found, server application 20 copies user C's profile to user B's contact list, and copies user B's profile to user C's contact list (step 37). The process is repeated until user B completes his contact list (step 3 8). User B can subsequently choose to download his contact list to his local PC or PDA (step 39).

If user C is not registered at the time user B includes him as a contact, user B's contact list will only contain user C's email address. When user C finally registers and creates his profile, user C's profile will be copied to user B's contact list, and user B's profile will also be copied to user C's contact list.

It should be appreciated by those skilled in the art that, as in steps 34 and 37 of the above example, copying user B's profile to user C's (or user A's) contact list and copying user C's (or user A's) profile to user B's contact list may be executed in either order or in parallel.

In another embodiment, a user can restrict other users from having a copy of his profile. In particular, the user is asked for permission before his profile is copied to another user's contact list. For example, when user B adds user A into user B's contact list, server application 20 will check if user B is already in user A's contact list. If user A's contact list does not contain user B, server application 20 will send a request to user A for permission to establish a bi-directional link between the two users. On the other hand, if user A's contact list has already included user B, user A will not be asked for permission.

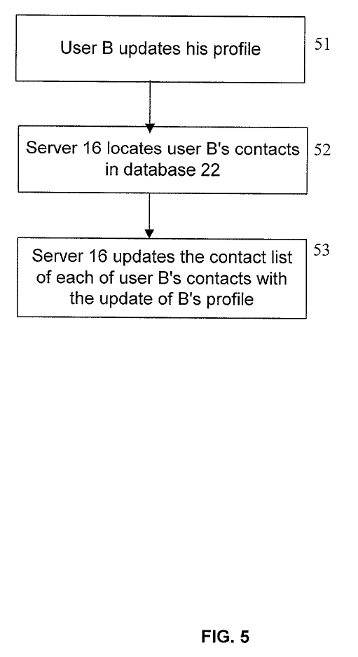

Referring to FIG. 5, a flow diagram illustrating the process of updating user B's profile is shown. When user B updates his profile (step 51), such as a change in job or phone number, he does not need to inform each of his contacts about the change. Server 16 will propagate the update to all other records in database 22 that contain user B's email address. Specifically, searching module 45 will locate the records of user B's contact in database 22 (step 52), and propagating module 47 will propagate the change to the contact lists of each of user B's contacts (step 53). The update in the profile automatically invokes the propagation of the update. The update can occur almost instantaneously in database 22, such that any of user B's contact will thereafter access the most up-to-date information about user B.

Like any other personal information, a user's email address is also subject to change. When a user's email address changes, the old email address can still serve as an index or a link, even though it is not possible to email the user at that email address. The email address functions as a pointer to a memory space that holds the information of the user. For example, assume Jane Smith creates her profile with the following information:

| | |
|---|---|
| Name: | Jane A. Smith |
| Email Address (1): | jsmith@ibm.com |
| Company: | IBM |
| Title: | Marketing Manager |
| Telephone: | 213-123-4567 |
| Address: | 100 Union Way, New York, NY 10012 |

When Jane Smith's employment status changes, her email address also changes. When she updates her profile in database 22 to reflect her new employment information, the email address (here, jsmith@ibm.com) will still serve as a pointer, albeit for the last time, for server application 20 to locate Jane Smith's profile for updating. When the updating is completed, Jane Smith's new profile, including her new email address, will be linked to her contacts automatically. All the linking and updating is transparent to Jane Smith's contacts.

In one scenario, updates in a user's profile do not propagate to the contact immediately. Specifically, an update in a user's profile propagates to a contact only when that contact reads the user's profile. Such delay in the propagation avoids massive updates in database 22, especially when a user with thousands of contacts changes his profile.

In one embodiment, server 16 and server application 20 inform a user of the existence of, and a change in, the profile of the user's contact using an “L” indicator. When a user B logs onto server 16 to view his contact list, user B will see a list of the names of his contacts on the screen of client machine 10b. When user B wishes to view the profile of a contact, he can request server application 20, for example, by clicking on the name of a contact. Server application 20 will cause that contact's profile to be displayed on the screen if that contact is registered and has created a profile in database 22. If user A, a contact of user B, is registered and has a profile in database 22, user B will see the “L” indicator appear next to user A's name in user B's contact list 21 on the screen, indicating that a copy of user A's profile is stored in information field 29 of user B's contact list 21.

When user A changes his profile, according to the scenario of delayed propagation as described above, propagation module 47 does not immediately propagate the change to user B's contact list 21. Server application 20 will cause a state of the indicator “L” associated with user A to change, e.g., from blue to red. The actual update of user A's profile copy does not occur until user B views user A's profile, for example, by clicking on user A's name displayed on the screen. Once user A's profile copy is updated in user B's contact list 21, the indicator “L” indicates the completion of the update by changing back its state, e.g., from red to blue.

In certain embodiments, server application 20 also allows a user to reject or delete a contact. Each contact in the contact list, when displayed on the screen of client machine 10, is associated with a “D” selector and an “R” selector for a user to delete and reject the corresponding contact, respectively.

When user B deletes user A from user B's contact list, the deletion completely removes the information of user A, including the copy of user A's profile, from user B's contact list. The deletion removes the bi-directional link between the records of user A and user B. As a result, user A will not be able to read any future updates in user A's profile. User A will still have user B's profile copy as of when the deletion occurs.

Rejection, on the other hand, can be viewed as an incomplete deletion. Referring again to FIG. 2, rejection list 23 of user B is stored in database 22 for user B to include his rejected contacts. If user B rejects user A, the rejection will only remove the bi-directional link to user A, thus preventing both users to view each others updates subsequent to the rejection. However, user B's profile copy in user A's contact list and user A's profile copy in user B's contact list stay unaffected.

Rejection can be used when a user has not decided whether to keep or delete a contact. When user B rejects user A, user A is removed from contact list 21 and is placed in rejection list 23. User B can later decide to delete user A, or to accept him back into contact list 21. When displayed on the screen of client machine 10, each rejected contact in rejection list 23 has an associated “D” selector and an “A” selector for user B to delete and accept the corresponding rejected contact, respectively.

In the embodiment described above in which a user restricts other users from having a copy of his profile, server application 20 will ask user A for permission before his profile is copied to user B's contact list. However, in the situation where user B accepts user A from rejection list 23, user A will not be asked for permission. The permission is not necessary because user A has already included user B as a contact, and the rejection by user B does not remove user B from user A's contact list. Once user B accepts user A, user A will be removed from rejection list 23 and placed into contact list 21. After returning to contact list 21, user A will be no different from any other contact of user B that has never been rejected.

The contact information management service provided by server 16 is not only designed for individual users, it is also designed for a group of people who are willing to share contact information, for example, members of a particular professional organization. A group account can be created for the group. Sharing a group account is an efficient and effective way to maintain and update contact information among the group. When an account is designated as a group account, any member of the group can view not only the profile of the group, but also the contact list of the group and the profile of any other member in the group. To a person who is not a member, a group account appears as a single contact person. If the non-member includes the group account as a contact, he will only be able to see the profile of the group.

The group account can dramatically reduce the time for members of a group to build their contact lists. For example, a professional organization may have 1000 members, which are all registered with server 16. Without a group account for the organization, a first member would have to enter 999 email addresses (excluding himself) to link to other members' profiles. A second member would have to enter 998 email addresses (excluding himself and the first member), and so on. On the other hand, if a group account exists for the members, each member's email address needs only be entered once. The group email address, as mentioned before, only serves as a memory pointer that points to the record of the group account. The email address does not have to be a valid address for email purpose, but must be unique within database 22.

A group account can be set up by a group account manager, who is authorized to maintain and overwrite the information in the group account. The group account manager can build the contact list for the group in the same way as an individual user builds his contact list, including copy-and-paste, file downloading, or simply typing the email addresses of all the members. Those members of the group who are registered will see the group name automatically appear in their contact lists, and will be able to view the profiles of other registered members.

An alternative approach to building the contact list of a group requires every member in the group to register, add the group's email as a contact, and indicate his wish to view the other members' profile. With this approach, it is possible for a non-member to view the group members' profile without a legitimate membership in the group. To prevent illegitimate access to the members' profiles, the group account manager is responsible for screening the contact list of the group.

Server application 20 further allows a user to build a profile that contains more than one email address at which the user can be reached. However, the only email address shown to a contact of the user is the one designated by the user. Thus, when the user is linked to other people, the designated address will be shown in the contact lists of these people. The can indicate the designated email address for each contact in his contact list.

In addition to multiple email addresses, a user can have a profile with multiple information levels. The higher the information level, the more detailed is the information. For example, the lowest information level may include name, company name, work phone number, and job title; the second lowest level additionally includes cell phone number; and the highest level includes home address and home phone number. The lowest information level is automatically available to all contacts unless the user upgrades the information levels for particular persons in his contact list. The user can manually upgrade the information level for each contact at any given time.

Server application 20 further allows a user to organize his contact list by a mechanism that enables the user to select any number of his contacts to form a sub-list. The user can assign a name to the sub-list to identify the function, organization, or location of the contacts in the sub-list. When the user wants to broadcast an email to the contacts in a sub-list, he can address it to the assigned name, and server application 20 will automatically translate the assigned name to the email addresses of the corresponding contacts.

A number of embodiments of the invention have been described. Nevertheless, it will be understood that various modifications may be made without departing from the spirit and scope of the invention. The specification and drawings are accordingly to be regarded in an illustrative rather than a restrictive sense. Accordingly, other embodiments are within the scope of the following claims.

What is claimed is:

1. A method of managing contact information comprising:
establishing a first record of a first user, the first record indexed by a first index associated with the first user, the first record including a first profile and a first list of contacts, each of the contacts having a record indexed by a unique index associated with the contact;
determining that a change has been made to the first profile;
locating each of the contacts in a database using the unique index; and
updating the record of each of the contacts with the change to the first profile.

2. The method of claim 1 further comprising:
adding a second user into the first list of contacts by inputting a second index of the second user;
searching the database to find a second record indexed by the second index, the second record including a second profile and a second list of contacts; and
linking the second record to the first record if the second record is found.

3. The method of claim 2 wherein linking the records includes copying the second profile to the first list of contacts, and copying the first profile to the second list of contacts.

4. The method of claim 2 wherein the linking step is controlled by the second user.

5. The method of claim 2 wherein the second record can be unlinked from the first record by allowing the second user to reject the first user, thereby preventing the first user from viewing subsequent updates in the second record.

6. The method of claim 1 wherein the first index comprises an email address.

7. The method of claim 1 wherein updating the records occurs when the first user submits the change to the first profile.

8. The method of claim 1 wherein updating the records occurs when a contact in the first list of contacts views the first profile.

9. The method of claim 1 wherein searching the database includes searching a plurality of databases, all of the databases conforming to a format for information storage and retrieval.

10. The method of claim 1 wherein the first record is indexed by a plurality of indices associated with the first user.

11. The method of claim 1 wherein the first profile includes a plurality of information levels, each level including different information relating to the first user, wherein the first user designates which of the information levels are accessible by a contact in the first list of contacts.

12. The method of claim 1 further comprising:
establishing a third record of a third user, the third record indexed by a third index associated with the third user, the third record including a third profile and a third list of contacts;
searching the database to find other records that contain the third index associated with the third user; and
linking the other records to the third record if the other records are found.

13. A method of managing contact information for a group of members comprising:
establishing a group record for the group, the group record indexed by an index associated with the group, the group record including a group profile and a list of group contacts, each of the group contacts being a member of the group and having a record; and
linking the group record to the record of each of the members.

14. The method of claim 13 wherein the group profile and the profiles of the members of the group are readable by any member of the group.

15. The method of claim 13 wherein a member of the group who has not been included in the list of group contacts can be added to the list by including the group as a contact in the member's record.

16. A system for managing contact information comprising:
a storage containing a database; and
a server operatively connected to the storage, the server being controlled by a server application program, the server being operative with the program to:
establish a first record of a first user, the first record indexed by a first index associated with the first user, the first record including a first profile and a first list of contacts, each of the contacts having a record indexed by a unique index associated with the contact;
determine that a change has been made to the first profile;
locate each of the contacts in the database using the unique index; and
update the record of each of the contacts with the change to the first profile.

17. The system of claim 16 wherein the server application program further controls the server to:
add a second user into the first list of contacts by inputting a second index of the second user;
search the database to find a second record indexed by the second index, the second record including a second profile and a second list of contacts; and
link the second record to the first record if the second record is found.

18. The system of claim 17 wherein linking the records includes copying the second profile to the first list of contacts, and copying the first profile to the second list of contacts.

19. The method of claim 17 wherein the linking step is controlled by the second user.

20. The system of claim 17 wherein the second record can be unlinked from the first record by allowing the second user to reject the first user, thereby preventing the first user from viewing subsequent updates in the second record.

21. The system of claim 16 wherein the first index comprises an email address.

22. The system of claim 16 wherein the server application program further controls the server to:
establish a third record of a third user, the third record indexed by a third index associated with the third user, the third record including a third profile and a third list of contacts;
search the database to find other records that contain the third index associated with the third user; and
link the other records to the third record if other records are found.

23. The system of claim 16 wherein the storage includes a plurality of storage units operatively connected through a network.

24. The system of claim 16 wherein the server includes a plurality of processing units operatively connected through a network.

25. A system for managing contact information for a group of members comprising:
a group record, indexed by an index associated with the group, the group record including a group profile and a list of group contacts, each of the group contacts being a member of the group and having a record; and
links, established between the group record and the record of each of the members.

26. The system of claim 25 wherein the group profile and the profiles of the members of the group are readable by any member of the group.

27. A computer program product residing on a computer readable medium comprising instructions for causing a computer to:
establish a first record of a first user, the first record indexed by a first index associated with the first user, the first record including a first profile and a first list of contacts, each of the contacts having a record indexed by a unique index associated with the contact;
determine that a change has been made to the first profile;
locate each of the contacts in the database using the unique index; and
update the record of each of the contacts with the change to the first profile.

28. The computer program product of claim 27 further comprising instructions for causing a computer to:
add a second user into the first list of contacts by inputting a second index of the second user;
search the database to find a second record indexed by the second index, the second record including a second profile and a second list of contacts; and
link the second record to the first record if the second record is found.

29. The computer program product of claim 27 wherein the first index comprises an email address.
